SEQUENCE LISTING (13 sequences)

SEQ ID NO: 1 - DNA, 52 bp, Artificial sequence
  consensus zinc finger gene fragment
ctgacttcgaaatcannntcgctgnnnaatgttnnngtagtcgcatgctgca

SEQ ID NO: 2 - DNA, 15 bp, Artificial sequence
  PCR primer
gactgaagctttagt

SEQ ID NO: 3 - DNA, 16 bp, Artificial Sequence
  PCR primer
gtcgctggtctactac

SEQ ID NO: 4 - DNA, 18 bp, Artificial Sequence
  partial complementary sequence to SEQ ID 1
gactgaagctttagtnnn

SEQ ID NO: 5 - DNA, 32 bp, Artificial Sequence
  complementary sequence to SEQ ID 3 and SEQ ID 6 (partially)
catcagcgtacgacgtcagcgaccagatgatg

SEQ ID NO: 6 - DNA, 42 bp, Artificial Sequence
  consensus zinc finger gene fragment
aatcannntcgctgnnnaatgttnnngtagtcgcatgctgca

SEQ ID NO: 7 - DNA, 15 bp, Artificial Sequence
  PCR primer
atgaccatgattacg

SEQ ID NO: 8 - DNA, 30 bp, Artificial Sequence
  complementary sequence to SEQ ID 7 and SEQ ID 1 (partially)
atgaccatgattacgctatgccatgactga

SEQ ID NO: 9 - DNA, 12 bp, Artificial Sequence
  partial complementary sequence to SEQ ID 1
agctttagtnnn

SEQ ID NO: 10 - DNA, 15 bp, Artificial Sequence
  PCR primer
acttgagactgaagc

SEQ ID NO: 11 - DNA, 15 bp, Artificial Sequence
  PCR primer
gcatgctagactgcc

SEQ ID NO: 12 - DNA, 21 bp, Artificial Sequence
  complementary sequence to SEQ ID 11 and SEQ ID 13 (partially)
catcagcgtacgatctgacgc

SEQ ID NO: 13 - DNA, 39 bp, Artificial Sequence
  consensus zinc finger gene fragment
acttcgaaatcannntcgctgnnnaatgttnnngtagtc

(19) United States
(12) Patent Application Publication
(10) Pub. No.: US 2006/0269913 A1
(43) Pub. Date: Nov. 30, 2006

(54) Methods of producing dna and protein libraries

(76) Inventors: Anna Victoria Hine, Worcestershire (GB); David Andrew Nagel, Rugby (GB); Marcus Daniel Hughes, West Midlands (GB); Zhan-Ren Zhang, Consett (GB); Mohammed Ashraf, Birmingham (GB); Andrew James Sutherland, Worcestershire (GB); Albert Francis Santos, Cardiff (GB)

Correspondence Address: FULBRIGHT AND JAWORSKI LLP, 555 S. FLOWER STREET, 41ST FLOOR, LOS ANGELES, CA, 90071, US

(21) Appl. No.: 10/518,174

(22) PCT Filed: Jun. 13, 2003
(86) PCT No.: PCT/GB03/02573

§ 371 Date: Jun. 28, 2005

(30) Foreign Application Priority Data
Jun. 14, 2002 (GB) 0213816.2

(51) Int. Cl. C40B 30/06; C40B 40/08

(52) U.S. Cl. 435/6

(57) ABSTRACT

The present invention provides a method of producing a DNA library comprising a plurality of DNA sequences of interest, where each DNA sequence of interest has at least two predetermined positions, with at each predetermined position a codon (MAX) selected from a defined group for that position, the codons within a group coding for different amino acids. The method comprising the steps of:—(i) contacting so as to effect hybridisation (a) template DNA (A) comprising said at least two predetermined positions, said template DNA being fully randomised at said at least two predetermined positions (NNN), (b) for each predetermined position, a selection oligonucleotide pool, each selection oligonucleotide (B) within each pool comprising a codon (MAX) selected from the defined group for that predetermined position, and (c) at least one additional oligonucleotide sequence (E) comprising a region (E2) which is non-hybridisable to the template DNA, (ii) ligating the hybridised DNA sequences (B, E), (iii) denaturing the product of step (ii) so as to give a mixed population of said template DNA (A) and said DNA sequences of interest, and (iv) selectively amplifying the DNA sequences of interest. The additional oligonucleotide sequence (E) of step (i) is selected such that after step (ii) the non-hybridisable region (E2) is located externally of the template DNA (A) The invention also provides protein and DNA libraries which can be produced by the method of the invention.

The present invention relates to methods of producing DNA libraries having randomised amino acid encoding codons at predetermined positions within the sequence and corresponding protein libraries.

Codon randonisation is performed to generate a randomised gene library, the library containing multiple variations of just one gene. Randomised codons may be separated by conserved sequences or else may be contiguous. The resulting gene libraries may be expressed to generate protein libraries, which are subsequently screened to find a protein with an activity of interest. The technique is used predominantly in protein engineering.

In the production of protein libraries standard randomisation techniques require an excess of genes to be cloned, since randomised codons NNN (64 codons where N represents A, T, G or C) or NNG/T (32 codons) must be cloned to ensure that all 20 amino acids are represented. Thus, as the number of randomised codons increases, the ratio of genes to proteins producible (i.e. a set in which every possible variation is represented) increases exponentially. Hine et al have recently described an alternative method for producing a DNA library which encodes for all amino acids at two or more predetermined positions that involves selective hybridisation of individually synthesised oligonucleotides to a traditionally randomised template to circumvent this problem (PCT publication WO 00/15777 which reference is incorporated herein in its entirety). The method involves, for each predetermined position, hybridising a pool of oligonucleotides to a region of a traditionally randomised template containing that predetermined position. Any given amino acid (at the predetermined position) is only encoded for once in each oligonucleotide pool. The technique is called “MAX” randomisation, and the codons chosen for the oligonucleotide probes are known as MAX codons. The benefit of the technique is that as the number of randomised codon positions increases, the ratio of genes to proteins producible remains constant. Although an improvement over traditional methods, since each gene encodes for a unique protein, this method results in a relatively high number (˜10%) of non-MAX (i.e. undesirable) codons at the randomised amino acid encoding positions. In addition, very small quantities of DNA containing the differing combinations of selected codons are produced making subsequent manipulations technically difficult.

It is an object of the present invention to obviate or mitigate one or more of the known problems by providing an improved method of producing DNA libraries encoding all possible amino acids at predetermined positions.

According to a first aspect of the present invention there is provided a method of producing a DNA library comprising a plurality of DNA sequences of interest, each DNA sequence of interest having at least two predetermined positions, with at each predetermined position a codon selected from a defined group for that position, the codons within a group coding for different amino acids, said method comprising the steps of:

(i) contacting so as to effect hybridisation (a) template DNA comprising said at least two predetermined positions, said template DNA being fully randomised at said at least two predetermined positions, (b) for each predetermined position, a selection oligonucleotide pool, each selection oligonucleotide within each pool comprising a codon selected from the defined group for that predetermined position, and (c) at least one additional oligonucleotide sequence comprising a region which is non-hybridisable to the template DNA,

(ii) ligating the hybridised DNA sequences,

(iii) denaturing the product of step (ii) so as to give a mixed population of said template DNA and said DNA sequences of interest, and

(iv) selectively amplifying the DNA sequences of interest,

wherein said additional oligonucleotide sequence of step (i) is selected such that after step (ii) the non-hybridisable region is located externally of (i.e. “overhangs”) the template DNA.

From the foregoing, it will be understood that each defined group may consist of up to but no more than 20 codons.

It will be understood that the term “predetermined position” as used herein refers to a specific codon position within the DNA sequence of interest and also to the corresponding codon position within the complementary template DNA.

It will be further understood that the term “template DNA” refers to a population of DNA sequences differing only at the predetermined positions, where the codon sequence is fully randomised (i.e. all possible trinucleotide combinations are represented at those positions). The DNA sequences may be a gene sequence or a partial gene sequence.

Preferably, said defined group consists of the codons:

AAA, AAC, ACC, AGC, ATG, ATT, CAG, CAT, CCG, CGC,
CTG, GAA, GAT,
GCG, GGC, GTG, TAT, TGG, TGC, TTT.

Hereinafter, these codons will be referred to as “MAX” codons. The MAX codons have been chosen since they represent the optimum codon usage for each amino acid in the model organism Escherichia coli. It will be readily apparent that, if desired, any of the MAX codons may be substituted for an alternative codon coding for the same amino acid. It may be desirable to substitute codons due to differing optimum codon usage in different organisms.

In particular, one or more of the defined groups may contain codons encoding for less than 20 amino acids. Thus, for each predetermined position, the defined groups may be the same or different. In some circumstances it may be desirable for a defined group to encode for less than 20 amino acids, for example if a particular amino acid or type of amino acid (e.g. basic, polar or non polar) is required at a particular predetermined position in the expressed protein.

Said additional oligonucleotide sequence may form part of the oligonucleotides in one of the selection pools. It will be understood that for the non-hybridisable region of the additional sequence to be located externally of the template DNA after step (ii), the additional sequence must be located towards an end (which must be the 3′ end for subsequent amplification) of the newly formed strand relative to the predetermined positions (i.e. the additional sequence cannot be between two predetermined positions).

Preferably, however, said additional oligonucleotide sequence is a separate oligonucleotide having a region complementary to the 5′ end of the template DNA.

Preferably, in step (i) each selection oligonucleotide pool is added in excess of that required to hybridise with template DNA (useable template DNA) where NNN of the relevant predetermined position is complementary to the MAX codons. Preferably, the ratio of each selection oligonucleotide pool to useable template DNA is at least 2:1, more preferably at least 5:1, even more preferably at least 10:1, and most preferably about 12:1.

In a first series of embodiments, the template DNA is attached to a support (e.g. polymeric bead) prior to step (i) such that after the denaturation (separation) of the double stranded DNA construct formed in step (ii), the template DNA is removed, for example by centrifugation or magnetism, before step (iv). Step (iv) is then effected by PCR utilising the overhanging non-hybridisable region of the additional sequence as a primer binding site (hence the requirement for it to be at the 3′ end of the sequence of interest).

In a second series of embodiments, the method includes contacting a second additional oligonucleotide sequence in step (i). This second additional oligonucleotide also comprises a non-hybridisable region, the second additional sequence being designed such that after step (ii) it is located at the 5′ end of the sequence of interest, with the non-hybridisable region overhanging the 3′ end of the template DNA. As with the first additional sequence, the second additional sequence may form part of the oligonucleotides in one of the selection pools, or it may be a separate oligonucleotide. During step (iv) a first primer complementary to the non-hybridisable region of the first additional sequence, and a second primer identical to the non-hybridisable region of the second additional sequence are used. It will be readily apparent to the skilled person that the first primer will bind to the sequence of interest at its 3′ end initiating synthesis of a complementary strand. The second primer will then hybridise to the complementary strand (at its 3′ end) thereby initiating synthesis of the sequence of interest. The primers will not bind the template DNA which will therefore not be amplified. As a result it is not necessary to remove the template DNA prior to step (iv).

Preferably, the amplified DNA sequences of interest are inserted after step (iv) into a suitable cloning vector. The cloning vector may be any type of prokaryotic or eukaryotic cloning vector such as an expression vector, an integrating vector or a bacteriophage vector and is chosen according to the intended use of the library.

Preferably, prior to insertion into the cloning vector, the DNA sequences are digested by a restriction endonuclease in order to generate the required cassette for cloning. For this purpose, a restriction endonuclease recognition site is present in the required location in the sequences of interest. The recognition site is preferably provided in the initial template DNA. Preferably, said restriction endonuclease recognition site is a unique site within the DNA sequence.

The sequences of interest, which will not generally be full gene sequences, may be inserted into an appropriate gene. The gene insertion step may be effected prior to or concomitantly with insertion into an appropriate cloning vector.

Preferably, the cloning vectors containing DNA sequences of interest are transformed into suitable host cells by any suitable method for example by heat shock, electroporation or by bacteriophage infection, after suitable packaging of a bacteriophage vector.

The present invention further resides in a DNA library producible by the method of the first aspect.

According to a second aspect of the present invention there is provided a method of producing a protein library comprising a plurality of polypeptides, each polypeptide having a different combination of amino acid residues in at least two predetermined positions, said method comprising the step of expressing the sequences of interest produced by the method of the first aspect.

It will be understood that the population of polypeptides produced have MAX encoded amino acid residues at positions corresponding to the predetermined positions in the DNA sequence of interest.

The present invention further resides in a protein library producible by the method of the second aspect.

The present invention still further resides in the use of said protein library to investigate binding interactions between the proteins (polypeptides) in the library and any appropriate ligand such as DNA, and other proteins or ligands. For example, said protein library can be used to investigate the binding interactions of randomised zinc fingers or randomised antibodies.

Embodiments of the invention will now be described, by way of example only, with reference to the accompanying diagrams in which:

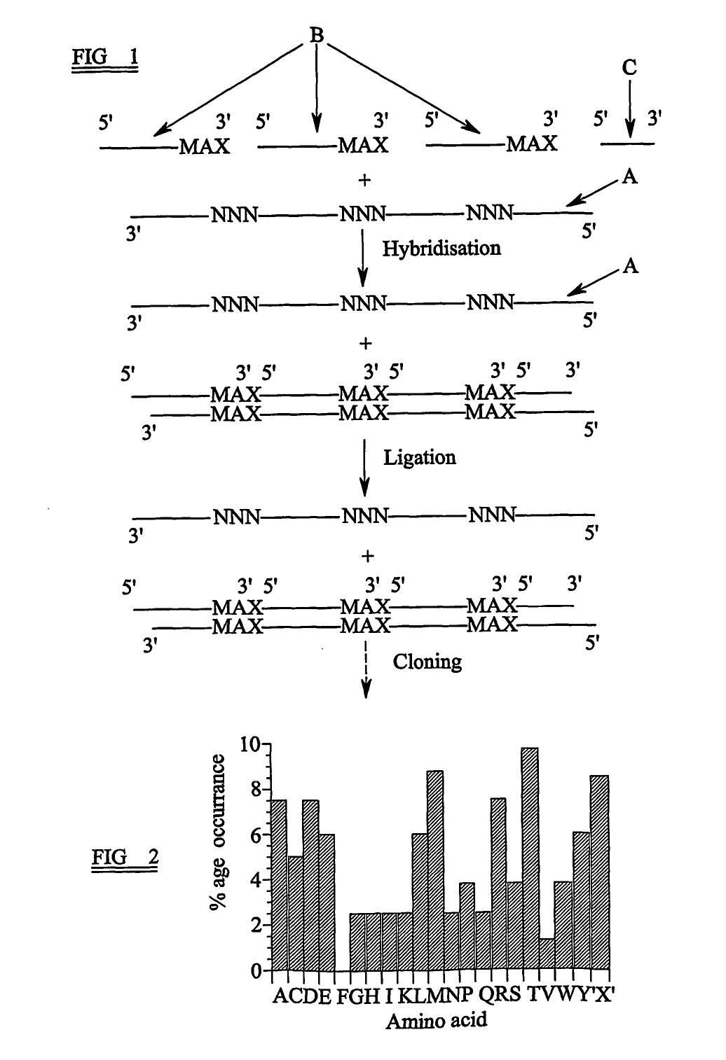

FIG. 1 shows schematically a method of producing DNA sequences containing MAX codons according to a comparative example,

FIG. 2 shows the distribution of MAX codons and non-MAX codons at the predetermined positions within a DNA sequence produced by the method of the comparative example,

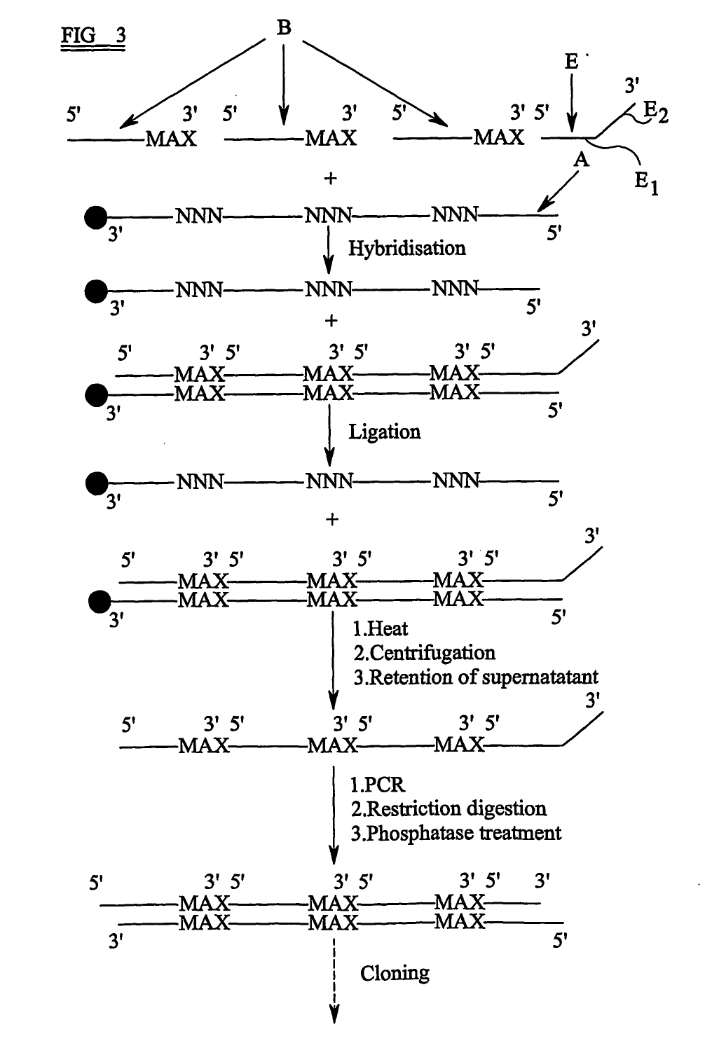

FIG. 3 shows schematically a method of producing DNA sequences containing MAX codons according to a first embodiment of the present invention,

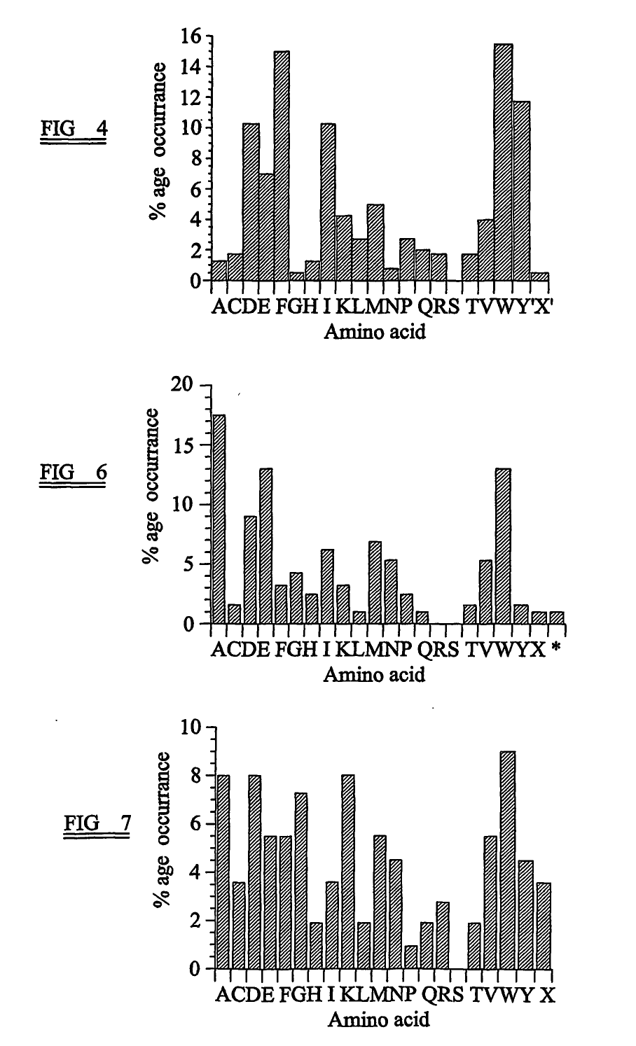

FIG. 4 shows the distribution of MAX codons and non-MAX codons at the predetermined positions within a DNA sequence produced by the method of the first embodiment of the present invention,

FIG. 5 shows schematically a method of producing DNA sequences containing MAX codons according to a second embodiment of the present invention,

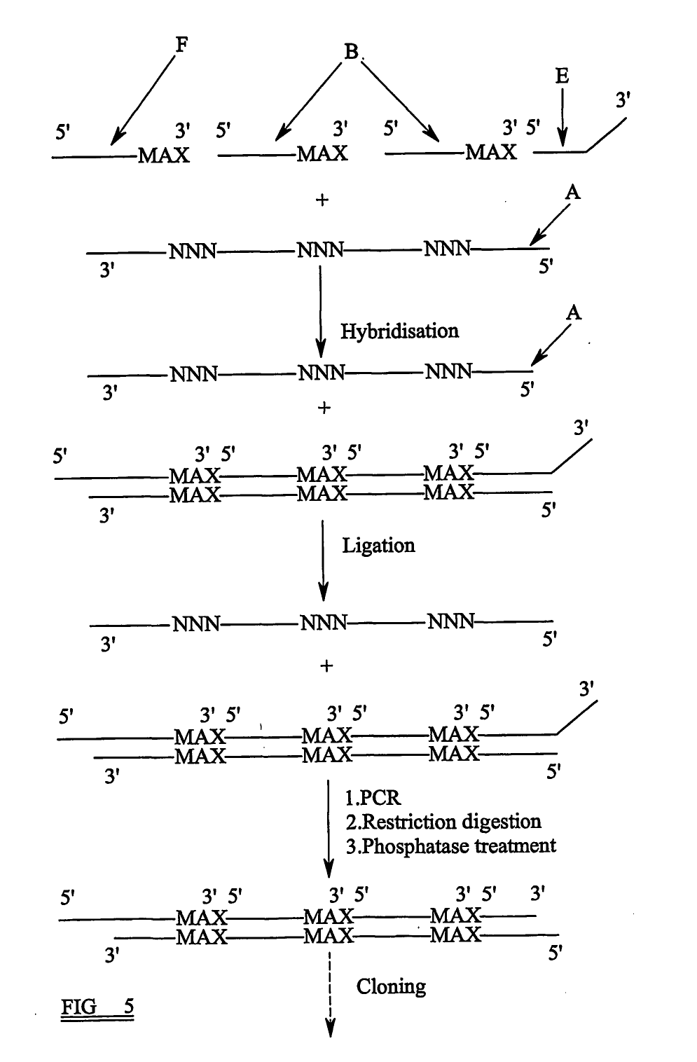

FIG. 6 shows the distribution of MAX codons and non-MAX codons at the predetermined positions within a DNA sequence produced by the method of the second embodiment of the present invention having a ratio of selection oligonucleotide : useful template DNA of about 1:1,

FIG. 7 shows the distribution of MAX codons and non-MAX codons at the predetermined positions within a DNA sequence produced by the method of the second embodiment of the present invention having a ratio of selection oligonucleotide: useful template DNA of about 12:1, and

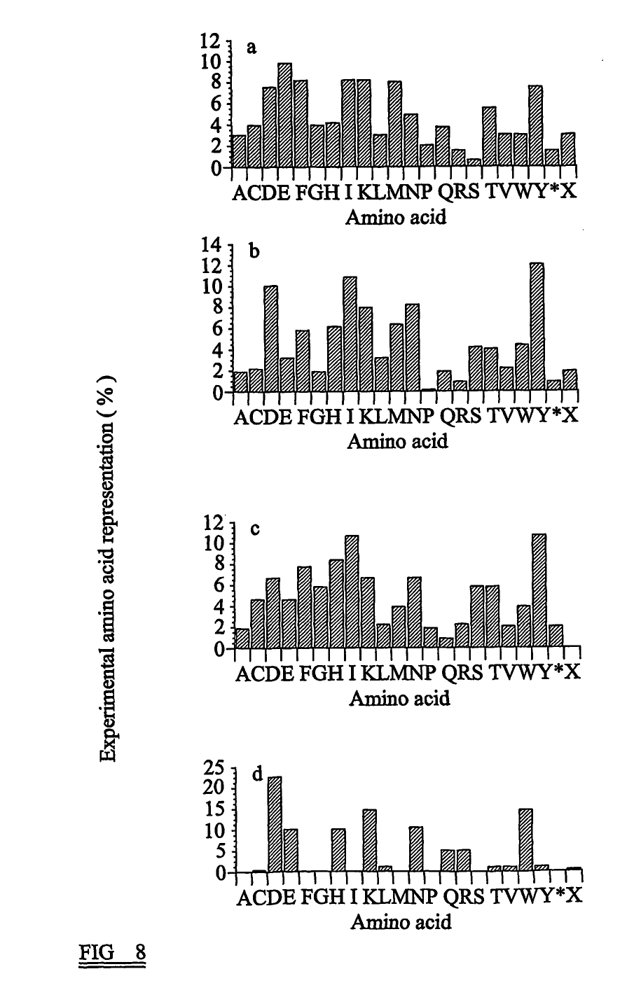

FIG. 8 shows the distribution of MAX codons and non-MAX codons for further embodiments of the present invention.

### PRODUCTION OF DNA LIBRARIES

### 1. COMPARATIVE EXAMPLE

FIG. 1 shows schematically a method of producing a randomised DNA library containing MAX codons at three specified positions according to a comparative example. In FIG. 1, “N” denotes the presence of any nucleotide, whereas MAX denotes a codon, each MAX codon being one of the group of 20 codons consisting of:

AAA, AAC, ACC, AGC, ATG, ATT, CAG, CAT, CCG, CGC,
CTG, GAA, GAT,
GCG, GGC, GTG, TAT, TGG, TGC, TTT.

Each of the above MAX codons codes for a different one of the 20 amino acids.

The main stages involved in the production of the library are:

1. mixing the template DNA (A) randomised at the predetermined positions, selection oligonucleotides (B) and an additional oligonucleotide (C) complementary to the 5′ end of the template DNA,

2. effecting hybridisation of the oligonucleotides to template DNA sequences which have codons complementary to the MAX codons at the predetermined positions,

3. ligating the hybridised sequences, and

4. inserting the double stranded DNA constructs into an appropriate vector.

The template DNA comprises a plurality of sequences which are identical other than at the predetermined positions (denoted by “N” in the template DNA). Selection oligonucleotides will not tend to hybridise at the predetermined positions to those template strands which do not have a sequence complementary to one of the MAX codons at any of these positions. It will be noted that in the comparative example shown, the template DNA extends in the 5′ direction beyond the endmost predetermined position. The additional oligonucleotide is complementary to this 5′ end region and its purpose is to ensure that double stranded DNA is formed for the required length of the template DNA.

Hybridisation, ligation and cloning were performed as described below and the cloned DNA constructs transformed into E. coli DH5α (genotype: F′ 80dlacZ(lacZYA-argF)U169 deoR recA1 endA1 hsdR17(rK−, mK+)phoA supE44-thi-1 gyrA96 relA1/F′ proAB+lacIqZM15 Tn10(tetr)) chemically competent cells, which were induced to take up DNA by heat shock. Clones were picked and plasmid DNA preparations undertaken. The inserts were then sequenced to identify the sequences of the codons present at the predetermined positions.

Materials and Methods

Template DNA Production

Template DNA was synthesised by MWG Biotech. At the three predetermined codon positions, i.e. the sites of randomisation, the nucleotide sequence NNN (where N represents any nucleotide) was specified. This results in a population of polynucleotide sequences in which all possible combinations of nucleotides are represented at the predetermined positions.

Selection Oligonucleotide Production

Selection oligonucleotides were synthesised by MWG Biotech. Selection oligonucleotides were designed so as to be complementary to contiguous regions of the template DNA, with each selection oligonucleotide containing one of the predetermined positions at its 3′ end. The selection oligonucleotides were synthesised in groups of 20 (one group or pool for each predetermined position) with each member of a group containing a different MAX codon. A set of three selection oligonucleotide pools were thus produced with each pool having all 20 MAX codons represented.

A further oligonucleotide was also synthesised. This further oligonucleotide being complementary to the template DNA from its 5′ end up to the nearest predetermined position, such that oligonucleotides complementary to the full length of the template DNA were present.

Phosphorylation

5′ Phosphorylation of appropriate selection oligonucleotide pools was performed by the addition of Polynucleotide Kinase (New England Biolabs) and ATP to the oligonucleotides suspended in PNK buffer (New England Biolabs) as per the manufacturer's instructions.

Hybridisation.

5 or 10 pmol of each selection oligonucleotide for each predetermined position (i.e. 100 or 200 pmol of oligonucleotides for each predetermined position) was mixed with 320pmol template DNA and 320pmol of the further oligonucleotide in a total volume of 50 μl hybridisation buffer (50 mM Tris-HCL pH 7.6, 10 mM MgCl₂, 4% w/v PEG8000 (GIBCO)) to give a selection oligonucleotide: complementary MAX-containing (“useful”) template DNA ratio of ˜1:1 or 2:1. The mix was heated to 95° C. for 3 minutes then cooled at a rate of 1° C./min to 26° C. to allow the complementary DNA sequences to hybridise. FIG. 2 shows the distribution of the different amino acid encoding codons from the combined results of these experiments.

Ligation

After hybridisation, 1 Weiss unit of ligase (Invitrogen), ATP to 2 mM and DTT to 1 mM were added to the hybridisation mix. This mix was incubated at 26° C. for 16 hours to allow the hybridised selection oligonucleotides to ligate.

Phenol Chloroform Extraction of DNA

The protein and DNA sequences were separated using phenol chloroform extraction. An equal volume of DNA suspension, phenol (pH 8) and 24:1 chloroform:iso-amyl alcohol were mixed vigorously and allowed to separate, the aqueous upper phase was carefully removed and a further extraction undertaken. A final chloroform extraction was undertaken to remove any traces of phenol from the DNA suspension. The DNA was then precipitated in ice-cold ethanol and resuspended in an appropriate volume of water.

Cloning

For gene randomisation, Plasmid pGST-ZFHMA3 was derived from plasmid pGST-ZFH, which encodes a glutathione S-transferase/zinc finger fusion protein. Briefly, a 37 bp cassette, encompassing the three codons to be randomised, was excised from pGST-ZFH by combined HindIII/BsiWI digestion. The cassette was then replaced with a 20bp oligonucleotide cassette that contained a central SmaI restriction site. The latter 20 bp cassette changes the reading frame of the remainder of the gene and so ensures that no functional zinc finger protein is encoded, unless a randomised, 37 bp cassette is inserted successfully.

In preparation for cloning, plasmid pGST-ZFHMA3 was digested with SmaI, HindIII and BsiWI. Combined HindIII/BsiWI digestion generates sticky ends complementary to those of the randomised cassette. Upon successful insertion of a randomised cassette, the original coding sequence of plasmid pGST-ZFH is restored, except at the randomised codons. The purpose of the SmaI digest (which generates blunt ends) is to cut the 20 bp cassette and so minimise any re-insertion. Note that the plasmid should not re-circularise in the absence of insert DNA, since HindIII and BsiWI do not produce complementary sticky ends.

Randomised cassettes (10 pmol total) were ligated at 16° C., overnight, into 100 ng of plasmid pGST-ZFHMA3 which had been pre-digested with SmaI, HindIII and BsiWI, under the ligation conditions described above. The ligations were transformed into chemically competent E. coli DH5α cells.

Preparation of Chemically Competent Cells

SOB medium (10 ml) was inoculated with a single colony and the resulting culture incubated with shaking at 37° C. overnight. The culture (8 ml) was inoculated into 800 ml SOB medium and the resulting culture incubated at 37° C. until an OD₅₅₀ of ˜0.45 was reached. The cells were chilled on ice for 30 mins and pelleted by centrifugation. The supernatant was removed by inversion and the pellet resuspended in 264 ml of RF1 buffer (100 mM RbCl, 50 MM MnCl₂, 30 mM potassium acetate, 10 mM CaCl₂, 15 % glycerol, adjusted to pH 5.8 with 0.2M acetic acid). The cells were incubated on ice for 60 mins, pelleted, resuspended in 64 ml RF2 buffer (10 M MOPS (4-morpholinepropanesulfonic acid), 10 mM RbCl, 75 mM CaCl₂, 15% glycerol, adjusted to pH 6.8 with NaOH) and incubated on ice for 15 mins. They were then dispensed into 200 μl aliquots in microfuge tubes, flash frozen in liquid nitrogen, and stored at −70° C. until required.

Transformation

Vectors were transformed into chemically competent cells by heat shock. An aliquot of chemically competent cells was thawed on ice, the DNA added and the mixture incubated on ice for 30 mins. The cells were heat shocked at 37° C. for 45 s and returned to ice for 2 mins. LB (800 μl) was added to each tube and the cells were incubated at 37° C. for 60 mins, with moderate agitation. The cells were plated onto selective medium.

Plasmid DNA Preparation

Plasmid preparations were either made by Wizard mini-prep (Promega), or else, in high throughput format, by Birmingham Genomics lab.

DNA Sequencing

DNA sequencing was performed by Birmingham Genomics lab on an ABI 3700 sequencer.

Results

### 1 COMPARATIVE EXAMPLE

FIG. 2 shows the distribution of the different amino acid encoding MAX codons at the predetermined positions in clones identified as containing a MAX encoding DNA sequence. A total of 27 clones were sequenced, giving 81 MAX encoding positions. FIG. 2 shows that this method of library production gives a reasonable distribution of MAX codons, the different codons being present at the three predetermined positions with a frequency of between 0 and about 10%, compared to the ideal distribution of 5% of each MAX codon. No phenylalanine (column F) encoding MAX codons were identified in this experiment, which may be due to degradation of the selection oligonucleotide or due to the relatively small sample size. Ideally there should be no non-MAX codons present at the predetermined positions. In the method according to the comparative example non-MAX codons (column X) occur with a frequency of about 9%. It is thought that non-MAX codons occur due to incorrect annealing of the template DNA and one or more of the selection oligonucleotides leading to mismatches. If the mismatches were tolerated during ligation, the host cell would randomly correct these to either the template sequence or the MAX sequence so that non-MAX codons could be fixed in some clones leading to a skewing of the distribution.

### 2. EXAMPLE 1

FIG. 3 shows schematically a method of producing randomised DNA libraries containing MAX codons at three specified positions according to a first embodiment of the present invention.

The main stages involved in the production of the library are:

1. mixing template DNA (A) (on a solid support (D)) randomised at the predetermined positions, selection oligonucleotides (B) and an additional oligonucleotide (E) having a first region (E₁) complementary to the 5′ end of the template DNA and a second non-hybridisable region (E₂),

2. effecting hybridisation of the oligonucleotides to template DNA sequences having codons complementary to the MAX codons at the predetermined positions,

3. ligating the hybridised sequences,

4. denaturing the double stranded DNA constructs,

5. removing the template DNA by centrifugation,

6. amplifying by PCR the MAX codon containing strand,

7. restriction digesting using an endonuclease to remove the non-required region of the resulting DNA cassette, and

8. cloning the double stranded DNA constructs into an appropriate vector.

Materials and Methods.

DNA Sequence Production.

Template DNA was synthesised onto Oligo-Affinity Support PolyStyrene (OASPS) beads (Glen Research) on a Beckman Oligo 1000 DNA synthesiser. Selection oligonucleotides were synthesised as described for the comparative example above.

An additional oligonucleotide complementary to a region of the template DNA from its 5′ end to the nearest predetermined position is also synthesised. This oligonucleotide is extended in its 3′ direction such that it extends beyond (i.e. overhangs) the template DNA. The extended region is non-complementary with the template DNA (and therefore will not hybridise) and serves as a binding site for a PCR primer so ensuring that only the MAX-codon containing strand is amplified. Phosphorylation, hybridisation and ligation were performed as described for the comparative example.

Template DNA Removal.

After the ligation step, the mix was heated to 95° C. for 5 mins to denature the duplex DNA, the mix was centrifuged at 14000 rpm for 1 min (Eppendorf microfuge) to remove the template DNA strands attached to the solid support leaving the newly ligated MAX encoding DNA sequences in the supernatant.

PCR.

PCR reactions were performed in a thermal cycler (MJ Engine, model PTC200) typically in a reaction volume of 100 μl. 1 μl of supernatant containing the single stranded MAX encoding DNA sequences was added to a PCR reaction mix (200 μM dNTPs, 50 μM primers, Pfu DNA polymerase (Promega), 10 μl 10× PCR reaction buffer (Pfu buffer (Promega)) made up to 100 μl with double distilled H₂O). One primer was designed so as to be complementary to the extended region at the 3′ end of the MAX encoding DNA sequences, and a second to be complementary to the 3′ end of the template DNA sequence. Even after template DNA removal, some template DNA may remain. In practice small amounts of template DNA in the PCR reaction mix does not adversely effect the distribution of MAX-codons. The template DNA is not exponentially amplified as it only contains one of the primer binding sites and so will effectively be diluted out. The reaction mix was heated to 95° C. for 2 min then 35 cycles of 94° C. 30 s, 48° C. 1 min, and 72° C. 30 s were performed before cooling to 4° C.

Restriction Endonuclease Digestion.

Restriction enzymes, NEBuffer 3 and Calf Intestinal Alkaline Phosphatase were obtained from New England Biolabs. Two PCR reactions were combined (200 μl), a 20 μl aliquot removed for examination and the remainder extracted with phenol/chloroform. The DNA was resuspended in 88 μl H₂O, 10 μl NEBuffer 3 (New England Biolabs) and 20 units HindIII. The digestion was incubated at 37° C. for 2 hrs and another 10 μl aliquot removed. BsiWI (20 units) was then added and the digest incubated at 55° C. for 16 hrs. Calf Intestinal Alkaline Phosphatase (10 units) was then added and the reaction incubated at 37° C. for 2 hrs. The resulting digest was extracted with phenol/chloroform and resuspended in 40 μl H₂O.

Subsequent steps were carried out in the same manner as for the comparative example.

The sequences of the template DNA, selection oligonucleotides and the 5′ and 3′ primer sequences were:

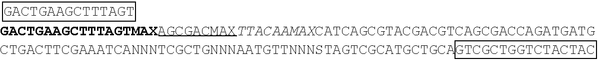

| | |
|---|---|
| 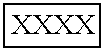 | PCR primers |
| MAX | 1st position MAX selection oligonucleotide |
| XXX | 2nd position MAX selection oligonucleotide |
| XXX | 3rd position MAX selection oligonucleotide |
| NNN | site of randoinisation. |

Results

FIG. 4 shows the distribution of the different MAX codons at the predetermined positions in clones identified as containing a MAX encoding DNA sequence. A total of 84 clones were sequenced giving 252 MAX encoding positions. FIG. 4 shows that this method of library production gives greatly reduced numbers of non-MAX codons, with their frequency reduced to below 1% (column X) as compared to about 9% in the library produced according to the method of the comparative example (FIG. 2, column X). This means that a DNA library containing known MAX sequences at the predetermined positions can be produced with a high degree of certainty, by controlling which MAX codon containing oligonucleotides are included in the selection pool.

The distribution of the different MAX codons, however, is poor compared to the ideal 5% incidence, varying from no serine encoding triplets (column S) to over 15% phenylalanine and tryptophan (columns F and W respectively). It is thought that the uneven representation of the various MAX codons may be due to unequal concentrations within the template oligonucleotide.

### 3. EXAMPLES 2a AND 2b

FIG. 5 shows schematically a method of producing a randomised DNA library containing MAX codons at three specified positions according a second embodiment of the present invention the method being similar to that of Example 1. Unlike Example 1, the template DNA is not synthesised on a bead and its removal prior to PCR is not necessary for reasons which will be explained below.

The most important difference between Example 1 and Example 2 is that the selection oligonucleotides (F) for the predetermined position nearest the 3′ end of the template DNA are extended at their 5′ end. The extension is non-hybridisable with and “overhangs” the template DNA. The 5′ extension is designed such that after the first round of PCR, the 3′ end of the newly formed strand (which is complementary to the 5′ extension) serves as the second primer binding site. Since neither primer will hybridise with the template DNA, only the required sequences are amplified, again, the restriction sites are within the template oligonucleotide.

In Example 2a, the ratio of selection oligonucleotides to template DNA and additional oligonucleotide was the same as for Example 1, being about 1:1 selection oligonucleotide: useful template DNA. In Example 2b, the ratio of selection oligonucleotides to template DNA and additional oligonucleotide was greater (about 40 pmol of each selection oligonucleotide to 210 pmol of template DNA and additional oligonucleotide) being about 12:1 selection oligonucleotide: useful template DNA.

The sequences of the template DNA, selection oligonucleotides and the 5′ and 3′ extended sequences were:

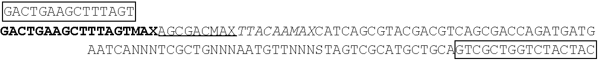

| | |
|---|---|
| 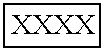 | PCR primers |
| MAX | 1st position MAX selection oligonucleotide |
| XXX | 2nd position MAX selection oligonucleotide |
| XXX | 3rd position MAX selection oligonucleotide |
| NNN | site of randomisation |

FIGS. 6 and 7 show the distribution of the different MAX codons at the predetermined positions in clones identified as containing MAX encoding DNA sequences produced from hybridisation mixes having selection oligonucleotide: useful template DNA ratios of 1:1 (Example 2a) and 12:1 (Example 2b) respectively.

In Example 2a, a total of 40 clones were sequenced giving 120 MAX encoding positions. FIG. 6 shows that this method of library production gives reduced numbers of non-MAX codons, with their frequency reduced to about 2% (column X and column*the latter designating a stop codon) as compared to about 9% in the library produced according to the method of the comparative example (FIG. 2, column X). However, the distribution of MAX codons is poor with large numbers of alanine, glutamic acid and tryptophan (columns A, E and W respectively) encoding codons present and no or very few leucine, glutamine, arginine or serine (columns (L, Q, R and S respectively) encoding codons.

In Example 2b, a total of 37 clones were sequenced giving 111 MAX encoding positions. FIG. 7 shows that this method of library production gives reduced numbers of non-MAX codons, with their frequency reduced to below 4% (column X) as compared to about 9% in the library produced according to the method of the comparative example (FIG. 2, column X), but higher numbers of non-MAX codons compared with the method of Example 1. However, the distribution of MAX codons encoding is better than for Example 1. The use of a large excess of selection oligonucleotides may improve the distribution of MAX codons by minimising the negative effect of any possible template DNA bias.

A comparison of FIGS. 6 and 7 shows that increasing the ratio of selection oligonucleotide sequences: useful template DNA greatly improves the distribution of MAX-codons present at the positions of interest. Although the number of non-MAX codons present increases slightly, this level is still below that seen in the comparative example.

### 4. EXAMPLE 3

When the complementary region between the overhang-containing oligonucleotide and the template DNA at its 3′ end is short and a MAX codon is located within the hybridising region of that oligonucleotide, the above method of library production may lead to a residual bias toward G/C rich MAX codons at that position due to the higher bond strength of G/C bonds compared with A/T bonds. To attempt to eliminate this bias, the template DNA has been extended at is 3′ end relative to that shown for Example 2 (the extended region being removed by a restriction endonuclease prior to cloning) and the relevant selection oligonucleotide divided into a constant sequence and a shorter selection oligonucleotide. This modification should prevent any G/C bias at that position of randomisation. New template DNA and new PCR primers having the sequences shown below have been synthesised and used to produce a DNA sequence library. It will be seen from the sequence below that the 3′ end of the template DNA has been extended by six bases beyond the end of the selection oligonucleotide at the 3′ end of the template DNA. If this overlap region is too long, for example 18 bases, then the second additional sequence can bind to the template DNA during PCR and act as a primer leading to unwanted amplification of the template DNA.

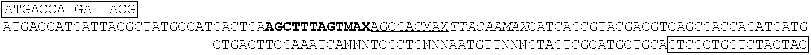

| | |
|---|---|
| 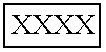 | PCR primers |
| MAX | 1st position MAX selection oligonucleotide |
| XXX | 2nd position MAX selection oligonucleotide |
| XXX | 3rd position MAX selection oligonucleotide |
| NNN | site of randomisation |

### 5. EXAMPLES 4a-c

In Example 4, a pair of constant oligonucleotides flanking the MAX selections oligonucleotides, template DNA and primers were used as indicated below.

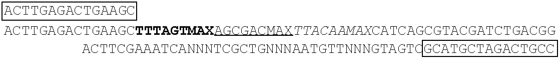

| | |
|---|---|
| 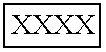 | PCR primers |
| MAX | 1st position MAX selection oligonucleotide |
| XXX | 2nd position MAX selection oligonucleotide |
| XXX | 3rd position MAX selection oligonucleotide |
| NNN | site of randoinisation |

In Example 4a, the amount of template and selection oligonucleotides were 320 pmol and 10 pmol respectively (about 2:1 selection oligonucleotide:useful template DNA). A total of 149 clones were sequenced.

In Examples 4b and 4c, the amount of template and selection oligonucleotides were 192 pmol and 36 pmol respectively (about 12:1 selection oligonucleotide:useful template DNA. In addition, in Example 4c, the “MAX” codons for Arg (CGC) and Ser (AGC) were replaced by the next most favoured codons CGT and AGT respectively, for reasons which will be explained below. A total of 76 (Example 4b) and 82 clones (Example 4c) were sequenced.

As expected, the distribution of MAX codons in Example 4a was reasonably good with relatively low frequency of non-MAX codons, however there is still some residual bias, for example poor serine representation (FIG. 8, panel a). Examples 4b and 4c were carried out in order to determine whether such bias is a random effect, the result of sequence toxicity, or differences in concentration of the selection oligonucleotides. Each of Examples 4b and 4c contained twelve-fold (rather than two-fold) excess concentrations of selection oligonucleotides, one with the same ‘MAX’ selection oligonucleotides (Example 4b) and a second in which the ‘MAX’ codons for Arg (CGC) and Ser (AGC) were replaced by the next most preferred codons, CGT and AGT, respectively (Example 4c). In each case, serine representation near to the ideal 5% level resulted (Example 4b: FIG. 8, panel b; Example 4c: FIG. 8, panel c), suggesting that codon sequence is not the cause of the poor serine representation found for Example 4a. Neither does selection oligonucleotide concentration appear to be the source of residual bias: whilst the increased concentration of selection oligonucleotides corresponds with increasing serine representation in Examples 4b and 4c, it also equates with decreased representation of glutamic acid. Moreover, in Example 4b and 4c the representation of Asp, Cys and Gly (for example) differ markedly, although the two Examples were conducted with parallel pools of MAX oligonucleotides (differing in only the two MAX oligonucleotides for Arg and Ser). Since bias is seen to vary from Example to Example, it is likely that the residual bias is random in nature, due to the small sample size.

### 6. EXAMPLE 5

In addition to full randomisation, ‘MAX’ randomisation should permit any required subset of amino acids to be encoded exclusively, simply by choosing the appropriate selection oligonucleotides. To examine this hypothesis, all three positions of the template DNA were randomised to encode only the amino acids D, E, H, K, N, Q, R & W (protocol as for Example 4a). This mixture comprises acidic, basic and amide-containing side groups. The results are shown in FIG. 8, panel d, from which it can be seen that MAX randomisation does indeed allow for required subsets of amino acids to be cloned almost exclusively. With a smaller library size, the representation of individual amino acids now approaches the idealised incidence (12.5% in this experiment) more closely. The low background of other non-selected codons again most likely results from single base mutations accrued during PCR and/or cloning.

Using the above embodiments to produce DNA sequence libraries having predetermined positions of randomisation also allows a number of consecutive codons to be randomised using trinucleotides as the selection oligonucleotide pools to hybridise to the randomised positions. This was not feasible using the method according to the comparative example due to potential misalignments leading to frameshift mutations.

1. A method of producing a DNA library comprising a plurality of DNA sequences of interest, each DNA sequence of interest having at least two predetermined positions, with at each predetermined position a codon selected from a defined group for that position, the codons within a group coding for different amino acids, said method comprising the steps of:
(i) contacting so as to effect hybridisation (a) template DNA comprising said at least two predetermined positions, said template DNA being fully randomised at said at least two predetermined positions, (b) for each predetermined position, a selection oligonucleotide pool, each selection oligonucleotide within each pool comprising a codon selected from the defined group for that predetermined position, and (c) at least one additional oligonucleotide sequence comprising a region which is non-hybridisable to the template DNA,
(ii) ligating the hybridised DNA sequences,
(iii) denaturing the product of step (ii) so as to give a mixed population of said template DNA and said DNA sequences of interest, and
(iv) selectively amplifying the DNA sequences of interest,
wherein said additional oligonucleotide sequence of step (i) is selected such that after step (ii) the non-hybridisable region is located externally of the template DNA.

2. The method of claim 1, wherein the defined group consists of the MAX codons which represent the optimum codon usage in a predetermined organism of interest, or a predetermined selection of said MAX codons.

3. The method of claim 1 or 2, wherein the defined group consists of the codons AAA, AAC, ACC, AGC, ATG, ATT, CAG, CAT, CCG, CGC, CTG, GAA, GAT, GCG, GGC, GTG, TAT, TGG, TGC, TTT which represent the MAX codons in the model organism Escherichia coli, or a predetermined selection therefrom.

4. The method of claim 2 or 3, wherein one or more of the MAX codons is substituted for an alternative codon coding for the same amino acid.

5. The method of any preceding claim 1, wherein the defined group consists of codons which code for amino acids having similar properties.

6. The method of claim 5, wherein said similar properties may be acidity or basicity, and/or hydrophobicity or hydrophilicity, and/or polarity or non-polarity.

7. The method of any preceding claim 1, wherein the defined group for each position is independently selected.

8. The method of any preceding claim 1, wherein the additional oligonucleotide sequence forms part of the oligonucleotides in one of the selection pools.

9. The method of any one of claims 1 to 7 claim 1, wherein the additional oligonucleotide sequence is a separate oligonucleotide having a region complementary to the 5′ end of the template DNA.

10. The method of any preceding claim 1, wherein in step (i) each selection oligonucleotide pool is added in excess of useable template DNA.

11. The method of claim 10, wherein the ratio of each selection oligonucleotide pool to useable template DNA is at least 2:1, preferably at least 5:1, more preferably at least 10:1, and most preferably about 12:1.

12. The method of any preceding claim 1, wherein, the template DNA is attached to a support prior to step (i) such that after the denaturation of the double stranded DNA construct formed in step (ii), the template DNA is removed before step (iv), step (iv) being effected by PCR utilising the overhanging non-hybridisable region of the additional oligonucleotide sequence as a primer binding site.

13. The method of any one of claims 1 to 11 claim 1, which includes a step of contacting a second additional oligonucleotide sequence in step (i), said second additional oligonucleotide also comprising a non-hybridisable region, the second additional sequence being designed such that after step (ii) it is located at the 5′ end of the sequence of interest, with the non-hybridisable region overhanging the 3′ end of the template DNA, and wherein step (iv) is effected using first primer complementary to the non-hybridisable region of the first additional sequence, and a second primer identical to the non-hybridisable region of the second additional sequence.

14. The method of claim 13, wherein the second additional sequence forms part of the oligonucleotides in one of the selection pools.

15. The method of any preceding claim 1, wherein the amplified DNA sequences of interest are inserted after step (iv) into a suitable cloning vector.

16. The method of claim 15, wherein the cloning vector is a prokaryotic or eukaryotic expression vector, an integrating vector or a bacteriophage vector, chosen according to the intended use of the library.

17. The method of claim 14 or 15, wherein prior to insertion into the cloning vector, the DNA sequences are digested by a restriction endonuclease in order to generate the required cassette for cloning, a restriction endonuclease recognition site being present in the required location in the sequences of interest.

18. The method of claim 17, wherein the recognition site is provided in the initial template DNA.

19. The method of any preceding claim 1, wherein the sequences of interest are inserted into an appropriate gene.

20. A DNA library producible by the method of claim 1 to 19.

21. A method of producing a protein library comprising a plurality of polypeptides, each polypeptide having a different combination of amino acid residues in at least two predetermined positions, said method comprising the step of expressing the sequences of interest produced by the method of claim 1 or from the DNA library of claim 20.

22. A protein library producible by the method of claim 21.

23. The use of the protein library of claim 22 to investigate binding interactions between the proteins (polypeptides) in the library and any appropriate ligand

24. The use of claim 23, to investigate the binding interactions of randomised zinc fingers or randomised antibodies.
